(19) United States
(12) Patent Application Publication
(10) Pub. No.: US 2026/0072372 A1
(43) Pub. Date: Mar. 12, 2026

(54) CHARGER

(71) Applicant: FUJIFILM Business Innovation Corp., Tokyo (JP)

(72) Inventors: Kazunari ISHII, Kanagawa (JP); Shunsuke YAMASAKI, Kanagawa (JP); Yasuhisa GONDA, Kanagawa (JP); Yuta SHIMATATE, Kanagawa (JP); Chihiro TONE, Kanagawa (JP); Tsutomu SUGIMOTO, Kanagawa (JP); Yuki NAGAMORI, Kanagawa (JP); Go MIURA, Kanagawa (JP)

(73) Assignee: FUJIFILM Business Innovation Corp., Tokyo (JP)

(21) Appl. No.: 19/054,916

(22) Filed: Feb. 17, 2025

(30) Foreign Application Priority Data
Sep. 10, 2024 (JP) 2024-156583

(51) Int. Cl. G03G 15/02; G03G 21/20

(52) U.S. Cl. CPC G03G 15/0291; G03G 21/206; G03G 2215/027; G03G 2221/1693

(57) ABSTRACT

A charger includes three or more odd-numbered wire electrodes that extend along an intersection direction intersecting a movement direction of a photosensitive body and being along a surface of the photosensitive body, and are arranged along the movement direction; a center counter electrode facing a center wire electrode that is arranged at a center in arrangement of the odd-numbered wire electrodes, and including a first portion and a second portion that are arranged in a region on a side opposite to the photosensitive body with respect to the center wire electrode, with a gap formed in the movement direction; end counter electrodes facing end wire electrodes that are arranged at both ends in the arrangement of the odd-numbered wire electrodes, and being positioned at both ends of the arrangement of the odd-numbered wire electrodes to sandwich the wire electrodes; and an air guide plate that directs a part of an airflow sent to a region surrounded by the center counter electrode and the two end counter electrodes toward the gap between the first portion and the second portion.

### CROSS-REFERENCE TO RELATED APPLICATIONS

This application is based on and claims priority under 35 USC 119 from Japanese Patent Application No. 2024-156583 filed Sep. 10, 2024.

### BACKGROUND

### (i) Technical Field

The present invention relates to a charger.

### (ii) Related Art

An electrophotographic image forming apparatus includes a charger that charges a surface of a photosensitive body on which an electrostatic latent image is formed. The surface of the photosensitive body is moved with respect to the charger, and the surface is charged. The charger has a wire electrode disposed adjacent to the photosensitive body, and a counter electrode disposed to surround three sides of the wire electrode excluding the photosensitive body side. The wire electrode extends along a direction orthogonal to a movement direction of the surface of the photosensitive body. Corona discharge is generated between the wire electrode and the counter electrode while moving the surface of the photosensitive body. As a result, the surface of the photosensitive body is charged. In addition, a grid electrode having a lattice shape may be disposed between the wire electrode and the photosensitive body.

A product generated by discharge or paper dust generated from a paper sheet may adhere to the wire electrode, the grid electrode, and the like. In order to suppress the adhesion, a device that sends an airflow to a space surrounded by the counter electrode may be provided. JP2015-184290A, JP2023-041455A, and JP2014-102271A disclose an image forming apparatus including a device that sends an airflow to a space surrounded by a counter electrode.

### SUMMARY

In a charger including three or more odd-numbered wire electrodes arranged along a movement direction of a surface of a photosensitive body, a counter electrode facing the wire electrode positioned at a center of the arrangement may hinder introduction of an airflow into a central region of a space surrounded by the counter electrode.

Aspects of non-limiting embodiments of the present disclosure relate to a charger that includes three or more odd-numbered wire electrodes, in which an airflow is sent to a central region of a space surrounded by a counter electrode in a movement direction of a surface of a photosensitive body.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a charger including three or more odd-numbered wire electrodes that extend along an intersection direction intersecting a movement direction of a photosensitive body and being along a surface of the photosensitive body, and are arranged along the movement direction; a center counter electrode facing a center wire electrode that is arranged at a center in arrangement of the odd-numbered wire electrodes, and including a first portion and a second portion that are arranged in a region on a side opposite to the photosensitive body with respect to the center wire electrode, with a gap formed in the movement direction; end counter electrodes facing end wire electrodes that are arranged at both ends in the arrangement of the odd-numbered wire electrodes, and being positioned at both ends of the arrangement of the odd-numbered wire electrodes to sandwich the wire electrodes; and an air guide plate that directs a part of an airflow sent to a region surrounded by the center counter electrode and the two end counter electrodes toward the gap between the first portion and the second portion.

### BRIEF DESCRIPTION OF THE DRAWINGS

Exemplary embodiment(s) of the present invention will be described in detail based on the following figures, wherein:

FIG. 1 is a diagram illustrating a schematic configuration of an image forming apparatus;

FIG. 2 is a perspective view schematically illustrating a schematic configuration of a photosensitive body and a charger;

FIG. 3 is a cross-sectional view schematically illustrating a schematic configuration of a photosensitive body and a charger;

FIGS. 4A and 4B are cross-sectional views illustrating a relationship between a center wire electrode and a center counter electrode, and a relationship between an end wire electrode and an end counter electrode;

FIGS. 5A to 5C are cross-sectional views illustrating other configuration examples of the center counter electrode; and

FIGS. 6A and 6B are cross-sectional views illustrating still other configuration examples of the center counter electrode.

### DETAILED DESCRIPTION

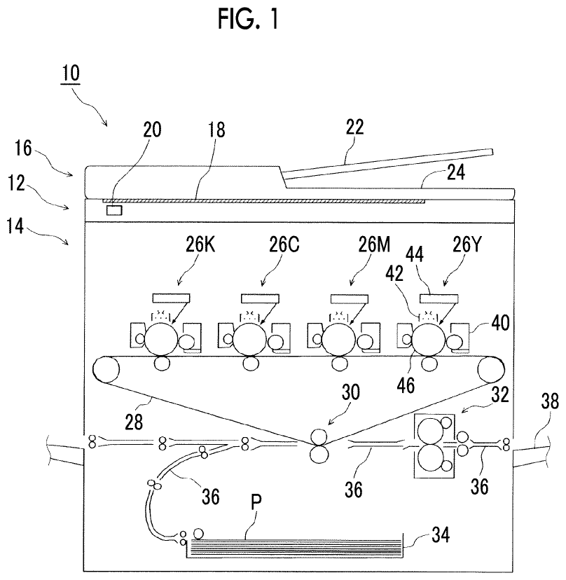

FIG. 1 is a diagram illustrating a schematic configuration of an image forming apparatus 10. The image forming apparatus 10 includes an image reading unit 12, an image forming section 14, and a document transport unit 16. The image reading unit 12 is a unit that optically reads an image of a document. The document is placed on a platen glass 18, and an image on the document is optically read by an image reading element 20 configured by a CCD or the like. The image of the entire document is read by moving the image reading element 20 along the platen glass 18. In addition, the document may be transported by the document transport unit 16, and the image on the document may be read by the image reading element 20 during the transport process. The document is transported one by one from a document feeding tray 22 of the document transport unit 16 to a document discharge tray 24, and is read during the process. In this case, the image of the entire document is read while the image reading element 20 remains stationary.

The image forming section 14 forms an image on a paper sheet P on the basis of image information read by the image reading unit 12 or image information sent from an external device such as a personal computer. The image forming section 14 is an electrophotographic device that forms a color image on the paper sheet P using four-color developer. The image forming section 14 includes image forming units 26Y, 26M, 26C, and 26K that respectively form developer images in each color of yellow (Y), magenta (M), cyan (C), and black (K). The image forming units 26Y, 26M, 26C, and 26K have no differences other than the color to form, and are referred to collectively as the image forming unit 26 by omitting Y, M, C, and K in a case where there is no need to distinguish between colors. The image forming section 14 includes an intermediate transfer belt 28 on which the developer image formed by the image forming unit 26 of each color is transferred, a transfer unit 30 that transfers the developer image on the intermediate transfer belt 28 to the paper sheet P, and a fixing unit 32 that fixes the transferred developer image on the paper sheet P. Furthermore, the image forming section 14 includes a paper sheet container 34 that accommodates the paper sheet P, and a paper sheet transport device 36 that transports the paper sheet P one by one from the paper sheet container 34, allowing the paper sheet P to sequentially pass through the transfer unit 30 and the fixing unit 32.

The developer image of each color formed by the image forming unit 26 is transferred and superimposed on the intermediate transfer belt 28. The developer image on the intermediate transfer belt 28 is sent to the transfer unit 30 along with the circulation of the intermediate transfer belt 28, and is transferred to the paper sheet P transported by the paper sheet transport device 36. The paper sheet P is further transported to the fixing unit 32 by the paper sheet transport device 36 to be heated and pressurized here, and the developer image is fixed on the paper sheet P. The paper sheet P on which the image is formed is sent to a paper discharge tray 38 by the paper sheet transport device 36.

As typically illustrated in the yellow image forming unit 26Y, the image forming unit 26 includes a developing apparatus 40, a charger 42, and an exposure device 44. The developing apparatus 40 supplies the developer to a photosensitive body 46. The charger 42 charges the surface of the photosensitive body 46. The exposure device 44 irradiates the surface of the charged photosensitive body 46 with light such as laser light to form an electrostatic latent image on the surface of the photosensitive body 46. The exposure device 44 controls the light to be emitted, on the basis of the image information acquired from the image reading unit 12 or the external device to form the electrostatic latent image. The developer is supplied from the developing apparatus 40 to the photosensitive body 46 on which the electrostatic latent image is formed, and the latent image is developed.

The image forming apparatus 10 includes four image forming units 26 corresponding to four colors of the developer. The number of image forming units corresponds to the number of colors of the developer. In a case where the developer is one color, the number of image forming units is one. In the image forming apparatus 10, the developer image formed by the image forming unit 26 is indirectly transferred to the paper sheet P via the intermediate transfer belt 28. Instead of this, the developer image may be directly transferred from the image forming unit to the paper sheet.

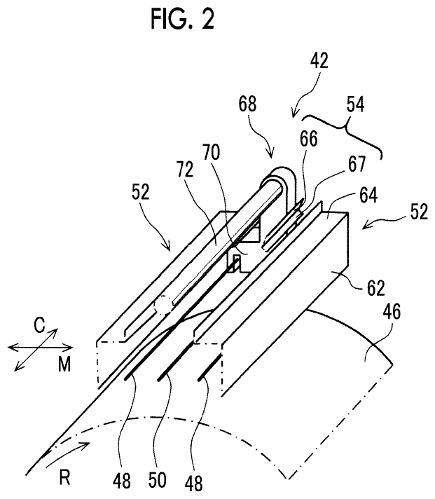

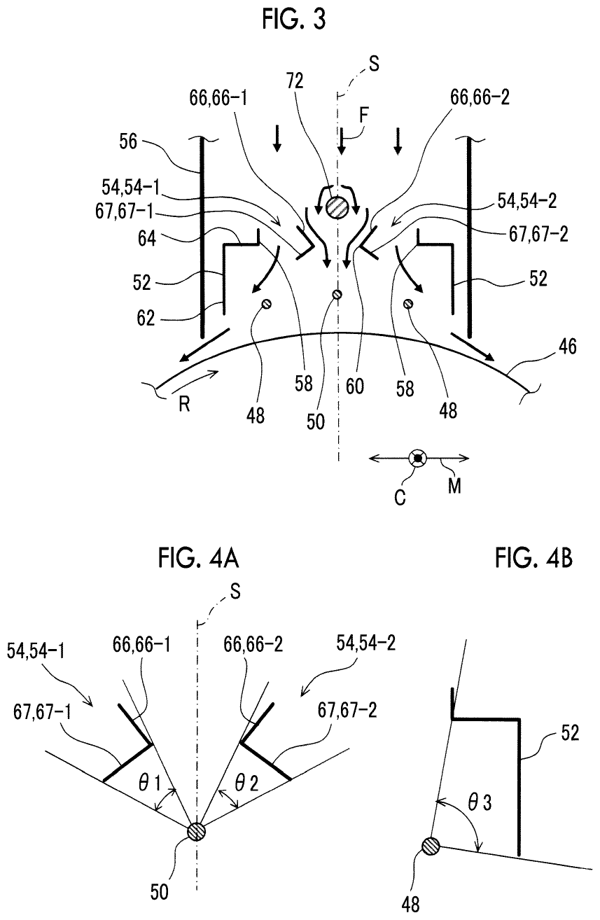

FIGS. 2 and 3 are diagrams illustrating the charger 42 and the photosensitive body 46. FIG. 2 is a perspective view, and FIG. 3 is a cross-sectional view. The charger 42 is disposed adjacent to the photosensitive body 46 having a cylindrical shape, and extends in a direction along a center line of the cylinder of the photosensitive body 46. The photosensitive body 46 is rotated clockwise in FIG. 3 with the center line thereof as an axis. The rotation direction is indicated by a reference numeral R in FIGS. 2 and 3. A direction along the movement of a portion of the photosensitive body 46, which faces the charger 42, is described as a “movement direction M”, and a direction intersecting the movement direction M, particularly a direction in which the center line of the photosensitive body 46 extends is described as an “intersection direction C”. In FIG. 3, a right-left direction is the movement direction M, and a direction penetrating the paper surface is the intersection direction C.

The charger 42 has a length corresponding to the photosensitive body 46 in the intersection direction C, and has a cross-sectional shape illustrated in FIG. 3 over the entire length. The charger 42 has three wire electrodes 48 and 50 extending along the intersection direction C and counter electrodes 52 and 54 arranged to face the wire electrodes 48 and 50. The three wire electrodes 48 and 50 are arranged along the movement direction M. The wire electrodes 48 positioned at both ends in this arrangement are referred to as end wire electrodes 48, and the wire electrode 50 positioned at the center is referred to as a center wire electrode 50. The counter electrodes 52 facing the end wire electrodes 48 are referred to as end counter electrodes 52, and the counter electrode 54 facing the center wire electrode 50 is referred to as a center counter electrode 54. The center counter electrode 54 is composed of two portions arranged with an interval, that is, a first portion 54-1 and a second portion 54-2. The configuration of the center counter electrode 54 will be described in detail later. A housing 56 is provided to surround the charger 42 from four sides in a plane defined by the movement direction M and the intersection direction C. In the housing 56, an airflow F sent from a fan (not illustrated) flows toward the photosensitive body 46. At least a part of the airflow F passes through the inside of the charger 42.

A counter electrode group including the end counter electrodes 52 and the center counter electrode 54 surrounds the three wire electrodes 48 and 50 from three sides other than the side facing the photosensitive body 46. That is, the counter electrode group surrounds the three wire electrodes 48 and 50 from the side opposite to the photosensitive body 46 and both sides in the movement direction M. The space surrounded by the counter electrode group is described as a “charger internal space”. The center wire electrode 50 is positioned at the center of the charger internal space in the movement direction M. In the counter electrode group, a bottom surface on the photosensitive body 46 side is open, and introduction openings 58 and 60 for introducing the airflow F flowing in the housing 56 are formed in a ceiling surface which is a surface on a side opposite to the bottom surface. The introduction opening 58 between the end counter electrodes 52 and the center counter electrode 54 is referred to as an end introduction opening 58. The introduction opening 60 between the first portion 54-1 and the second portion 54-2 of the center counter electrode is referred to as a center introduction opening 60. The airflow F flows to the charger internal space through the end introduction opening 58 and the center introduction opening 60. Surfaces of the counter electrode group, which are positioned to sandwich the three wire electrodes 48 and 50 in the movement direction M, are referred to as side surfaces.

The end counter electrode 52 includes a side surface member 62 that forms the side surface of the counter electrode group, and a ceiling surface member 64 that forms a part of the ceiling surface. The center counter electrode 54 forms a part of the ceiling surface of the counter electrode group. Furthermore, the first portion 54-1 and the second portion 54-2 of the center counter electrode are arranged to form a gap in a region on a side opposite to the photosensitive body 46 with respect to the center wire electrode 50. That is, the first portion 54-1 and the second portion 54-2 are arranged with an opening above the center wire electrode 50 in FIG. 3. The first portion 54-1 and the second portion 54-2 define the center introduction opening 60 60 therebetween. The first portion 54-1 and the second portion 54-2 of the center counter electrode have a right-left symmetric shape, and are arranged symmetrically with respect to a plane (hereinafter, referred to as a central surface S) defined by the center wire electrode 50 and the center line of the photosensitive body 46.

The charger 42 further includes an air guide plate 66 that directs a part of the airflow F to the gap between the first portion 54-1 and the second portion 54-2 of the center counter electrode, that is, the center introduction opening 60. The air guide plate 66 is formed as a part of the center counter electrode 54. The air guide plate 66 as a part of the first portion 54-1 of the center counter electrode is referred to as a first air guide plate 66-1, and a portion of the first portion 54-1 other than the first air guide plate 66-1 is referred to as a first electrode plate 67-1. The first electrode plate 67-1 faces the center wire electrode 50. The air guide plate 66 as a part of the second portion 54-2 of the center counter electrode is referred to as a second air guide plate 66-2, and a portion of the second portion 54-2 other than the second air guide plate 66-2 is referred to as a second electrode plate 67-2. The second electrode plate 67-2 faces the center wire electrode 50. In a case where there is no need to distinguish between the first electrode plate 67-1 and the second electrode plate 67-2, the first electrode plate 67-1 and the second electrode plate 67-2 are described as the electrode plate 67. The first air guide plate 66-1 and the second air guide plate 66-2 are respectively arranged on the sides of the first portion 54-1 and the second portion 54-2 of the center counter electrode, opposite to the photosensitive body 46. In addition, the first air guide plate 66-1 and the second air guide plate 66-2 are respectively arranged on the upstream side of the first portion 54-1 and the second portion 54-2 in the airflow F.

The charger 42 includes a cleaner 68 that removes the attachments of the wire electrodes 48 and 50. The cleaner 68 includes a cleaner head 70 that grips the wire electrodes 48 and 50. The cleaner head 70 is moved along the intersection direction C by being guided by a rod-like guide rod 72 by a drive mechanism (not illustrated). In the process of the movement, the attachments are removed by rubbing the surfaces of the wire electrodes 48 and 50.

As illustrated in FIG. 3, the two air guide plates 66 are arranged in a tapered shape such that an interval on the photosensitive body 46 side is narrower than an interval on the opposite side. With this arrangement, a large amount of airflow F is directed toward the central region of the charger internal space in the movement direction M. The air guide plate 66 may be formed integrally with the electrode plate 67 by bending a conductive plate material such as a steel plate. Alternatively, the air guide plate 66 may be disposed to be separated from the electrode plate 67. In this case, the material of the air guide plate 66 is not limited to a conductive material, and a non-conductive material such as a resin may be adopted. In addition, the air guide plate 66 made of a non-conductive material may be disposed in contact with the electrode plate 67. In a case where the air guide plate 66 is made of a non-conductive material, the air guide plate 66 does not function as an electrode.

A solid angle subtended by the first portion 54-1 and the second portion 54-2 of the center counter electrode from one point on the center wire electrode 50 may be made equal to a solid angle subtended by the corresponding end counter electrodes 52 from one point on the end wire electrodes 48, which is at the same position in the intersection direction C as the one point on the center wire electrode 50. The effect of the discharge related to the center wire electrode 50 and the effect of the discharge related to the end wire electrodes 48 are equivalent.

The charger 42 is a corotron charger in which the bottom surface of the counter electrode group is open, but may be a scorotron charger in which a grid electrode having a lattice shape is disposed on the bottom surface.

FIGS. 4A and 4B are diagrams illustrating a relationship between the center wire electrode 50 and the center counter electrode 54 and a relationship between the end wire electrodes 48 and the end counter electrodes 52. FIGS. 4A and 4B illustrate cross sections orthogonal to the intersection direction C. The lengths of the center counter electrode 54 and the end counter electrodes 52 in the intersection direction C are substantially the same. The air guide plate 66 is hidden in the shadow of the electrode plate 67 as viewed from the center wire electrode 50. The sum of an angle θ1 subtended by the first portion 54-1 of the center counter electrode from the center wire electrode 50 and an angle θ2 subtended by the second portion 54-2 of the center counter electrode from the center wire electrode 50 may be made equal to an angle θ3 subtended by the end counter electrodes 52 from the end wire electrode 48 (θ1+θ2=θ3). The effect of the discharge related to the center wire electrode 50 and the effect of the discharge related to the end wire electrodes 48 are equivalent. Note that since the first portion 54-1 and the second portion 54-2 of the center counter electrode are symmetrically arranged, the angle θ1 and the angle θ2 are equal to each other (θ1=θ2, θ1×2=θ3).

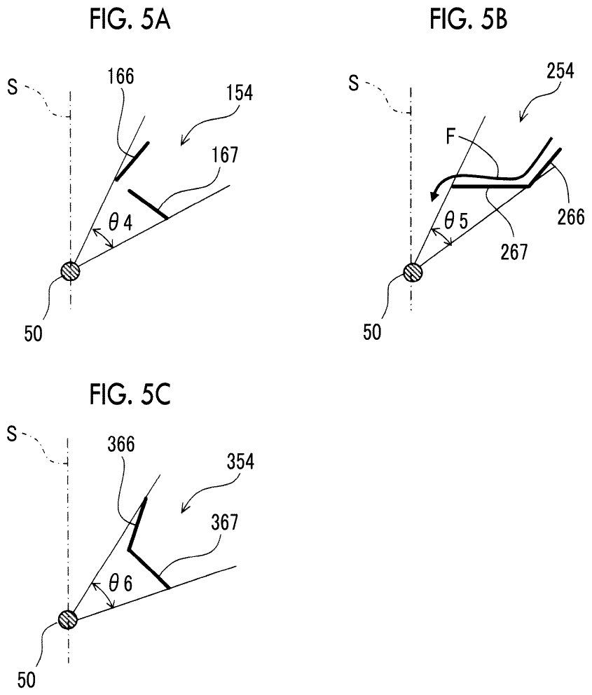

FIGS. 5A to 5C are diagrams illustrating other configuration examples of the center counter electrode. In FIGS. 5A to 5C, only one side of the center counter electrode symmetrically disposed is illustrated. In addition, the center counter electrode of each configuration example illustrated in FIGS. 5A to 5C can be substituted for the above-described center counter electrode 54.

In a center counter electrode 154 illustrated in FIG. 5A, an air guide plate 166 and an electrode plate 167 are separated from each other. In addition, the air guide plate 166 is not hidden by the electrode plate 167 and is exposed, as viewed from the center wire electrode 50. In a case where the air guide plate 166 is formed of a conductive member, the air guide plate 166 functions as a part of the center counter electrode. An angle θ4 subtended by the center counter electrode 154 from the center wire electrode 50 may be ½ of the angle θ3 subtended by the end counter electrodes 52 from the end wire electrode 48 described above.

In a center counter electrode 254 illustrated in FIG. 5B, an electrode plate 267 is disposed along a plane orthogonal to the normal line of the surface of the photosensitive body 46, which passes through the center wire electrode 50. With this arrangement, the design and the manufacture of the charger 42 are simplified. Air guide plates 266 arranged on the right and left sides of the central surface S extend further apart from each other from the edges, which are on the sides apart from each other, of the two electrode plates 267 that are symmetrically arranged. In addition, the right and left air guide plates 266 are arranged in a tapered shape in which the edges on the photosensitive body 46 side are narrow, as in the air guide plate 66. The airflow F received by the air guide plate 266 flows along the air guide plate 266, and then flows along the electrode plate 267 toward the center introduction opening 60. The electrode plate 267 also functions as the air guide plate. The air guide plate 266 is hidden in the shadow of the electrode plate 267 as viewed from the center wire electrode 50. An angle θ5 subtended by the center counter electrode 254 from the center wire electrode 50 may be ½ of the angle θ3 subtended by the end counter electrodes 52 from the end wire electrode 48 described above.

In a center counter electrode 354 illustrated in FIG. 5C, an electrode plate 367 and an air guide plate 366 are integrated as in the center counter electrode 54 described above, but the center counter electrode 354 is different from the center counter electrode 54 in that the air guide plate 366 is not hidden by the electrode plate 367 and is exposed in a case of being viewed from the center wire electrode 50. The air guide plate 366 is formed of a conductive member such as a steel plate, and thus the air guide plate 366 functions as a part of the center counter electrode 354. An angle θ6 subtended by the center counter electrode 354 from the center wire electrode 50 may be ½ of the angle θ3 subtended by the end counter electrodes 52 from the end wire electrode 48.

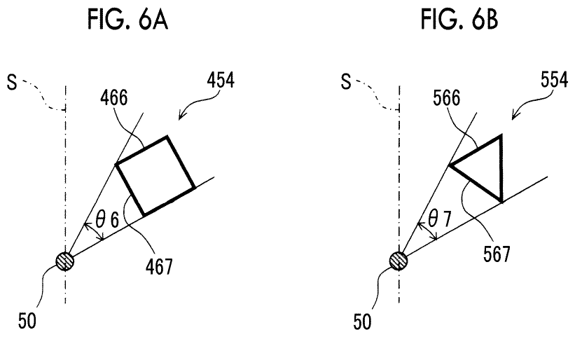

FIGS. 6A and 6B are diagrams illustrating still other configuration examples of the center counter electrode. In FIGS. 6A and 6B, only one side of the center counter electrode symmetrically disposed with respect to the central surface S is illustrated. The center counter electrode illustrated in FIGS. 6A and 6B has a polygonal cross-sectional hollow cylindrical shape, one side surface thereof is an electrode plate facing the center wire electrode 50, and another side surface thereof functions as an air guide plate. In addition, the center counter electrode of each configuration example illustrated in FIGS. 6A and 6B can be substituted for the center counter electrode 54 described above.

A center counter electrode 454 illustrated in FIG. 6A has a square cross section, particularly a square cross-sectional tubular shape. A side surface facing the center wire electrode 50 is an electrode plate 467, and a side surface facing upward in FIG. 6A functions as an air guide plate 466. A center counter electrode 554 illustrated in FIG. 6B has a triangular cross section, particularly a tubular shape. A side surface facing the center wire electrode 50 is an electrode plate 567, and a side surface facing upward in FIG. 6B functions as an air guide plate 566.

In a charger including five or more odd-numbered wire electrodes, as in the charger including three wire electrodes, the counter electrode facing the center wire electrode may hinder the introduction of the airflow to the central region of the charger internal space. Even in the charger including five or more odd-numbered wire electrodes, as in the charger 42 including three wire electrodes described above, the center counter electrode facing the center wire electrode is divided into two portions, the two portions are spaced form an introduction opening, and the airflow F is introduced to the central region inside the charger. In addition, by providing an introduction plate that directs the airflow toward the introduction opening between the two portions of the center counter electrode, a large amount of airflow is introduced to the central region as compared with a case where the introduction plate is not provided.

### Supplementary Notes

(((1)))

A charger comprising:
three or more odd-numbered wire electrodes that extend along an intersection direction intersecting a movement direction of a photosensitive body and being along a surface of the photosensitive body, and are arranged along the movement direction;
a center counter electrode facing a center wire electrode that is arranged at a center in arrangement of the odd-numbered wire electrodes, and including a first portion and a second portion that are arranged in a region on a side opposite to the photosensitive body with respect to the center wire electrode, with a gap formed in the movement direction;
end counter electrodes facing end wire electrodes that are arranged at both ends in the arrangement of the odd-numbered wire electrodes, and being positioned at both ends of the arrangement of the odd-numbered wire electrodes to sandwich the wire electrodes; and
an air guide plate that directs a part of an airflow sent to a region surrounded by the center counter electrode and the two end counter electrodes toward the gap between the first portion and the second portion.
(((2)))

The charger according to (((1))),
wherein the air guide plate includes a first air guide plate and a second air guide plate, the first air guide plate is a part of the first portion of the center counter electrode, and the second air guide plate is a part of the second portion of the center counter electrode.
(((3)))

The charger according to (((2))),
wherein the first air guide plate is formed integrally with the first portion as a part of the first portion of the center counter electrode, and
the second air guide plate is formed integrally with the second portion as a part of the second portion of the center counter electrode.
(((4)))

The charger according to any one of (((1))) to (((3))),
wherein a solid angle subtended by the center counter electrode from a point on the center wire electrode is equal to a solid angle subtended by the end counter electrode from a point on the end wire electrode at the same position as the point on the center wire electrode in the intersection direction.
(((5)))

The charger according to (((1))),
wherein the air guide plate includes a first air guide plate and a second air guide plate, and
the first air guide plate and the second air guide plate are arranged in a tapered shape such that a photosensitive body side is narrow.
(((6)))

The charger according to (((5))),
wherein the first air guide plate is formed integrally with the first portion as a part of the first portion of the center counter electrode,
the second air guide plate is formed integrally with the second portion as a part of the second portion of the center counter electrode, and
the first portion and the second portion of the center counter electrode include an electrode plate disposed along a plane orthogonal to a normal line of a surface of the photosensitive body, the normal line passing through the center wire electrode.
(((7)))

The charger according to (((6))),
wherein the first air guide plate and the second air guide plate extend further apart from each other from edges of the electrode plate of the first portion and the electrode plate of the second portion, which are on sides apart from each other.
(((8)))

The charger according to any one of (((1))) to (((4))),
wherein the first air guide plate and the second air guide plate are arranged in a tapered shape such that a photosensitive body side is narrow.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charger comprising:
three or more odd-numbered wire electrodes that extend along an intersection direction intersecting a movement direction of a photosensitive body and being along a surface of the photosensitive body, and are arranged along the movement direction;
a center counter electrode facing a center wire electrode that is arranged at a center in arrangement of the odd-numbered wire electrodes, and including a first portion and a second portion that are arranged in a region on a side opposite to the photosensitive body with respect to the center wire electrode, with a gap formed in the movement direction;
end counter electrodes facing end wire electrodes that are arranged at both ends in the arrangement of the odd-numbered wire electrodes, and being positioned at both ends of the arrangement of the odd-numbered wire electrodes to sandwich the wire electrodes; and
an air guide plate that directs a part of an airflow sent to a region surrounded by the center counter electrode and the two end counter electrodes toward the gap between the first portion and the second portion.

2. The charger according to claim 1,
wherein the air guide plate includes a first air guide plate and a second air guide plate,
the first air guide plate is a part of the first portion of the center counter electrode, and
the second air guide plate is a part of the second portion of the center counter electrode.

3. The charger according to claim 2,
wherein the first air guide plate is formed integrally with the first portion as a part of the first portion of the center counter electrode, and
the second air guide plate is formed integrally with the second portion as a part of the second portion of the center counter electrode.

4. The charger according to claim 1,
wherein a solid angle subtended by the center counter electrode from a point on the center wire electrode is equal to a solid angle subtended by the end counter electrode from a point on the end wire electrode at the same position as the point on the center wire electrode in the intersection direction.

5. The charger according to claim 2,
wherein a solid angle subtended by the center counter electrode from a point on the center wire electrode is equal to a solid angle subtended by the end counter electrode from a point on the end wire electrode at the same position as the point on the center wire electrode in the intersection direction.

6. The charger according to claim 3,
wherein a solid angle subtended by the center counter electrode from a point on the center wire electrode is equal to a solid angle subtended by the end counter electrode from a point on the end wire electrode at the same position as the point on the center wire electrode in the intersection direction.

7. The charger according to claim 1,
wherein the air guide plate includes a first air guide plate and a second air guide plate, and
the first air guide plate and the second air guide plate are arranged in a tapered shape such that a photosensitive body side is narrow.

8. The charger according to claim 7,
wherein the first air guide plate is formed integrally with the first portion as a part of the first portion of the center counter electrode,
the second air guide plate is formed integrally with the second portion as a part of the second portion of the center counter electrode, and
the first portion and the second portion of the center counter electrode include an electrode plate disposed along a plane orthogonal to a normal line of a surface of the photosensitive body, the normal line passing through the center wire electrode.

9. The charger according to claim 8,
wherein the first air guide plate and the second air guide plate extend further apart from each other from edges of the electrode plate of the first portion and the electrode plate of the second portion, which are on sides apart from each other.
